(19) United States
(12) Patent Application Publication
(10) Pub. No.: US 2004/0173073 A1
(43) Pub. Date: Sep. 9, 2004

(54) Pouch machine with a rotary die cutter

(76) Inventor: Kenneth R. Wilkes, Asheville, NC (US)

Correspondence Address: Saul Epstein, 14558 Deervale Place, Sherman Oaks, CA, 91403, US

(21) Appl. No.: 10/379,360

(22) Filed: Mar. 4, 2003

(51) Int. Cl. B26D 5/38

(52) U.S. Cl. 83/371

(57) ABSTRACT

A pouch making machine with a rotary die cutter, which sets a repeat distance between die outlines on a die roller greater than the repeat distance of printing on a web. An eyespot is placed adjacent to each pouch on the web. A die encoder monitors the position of the die outlines on the die roller. A photosensitive sensor reads the position of the eyespots on the web. A pair of nip rollers are driven by a variable speed motor and monitored by an encoder. A controller inputs location information from the rotary die cutter and the photosensitive sensor. The controller instantaneously slows the speed of the pair of nip rollers to retard the advance of the web, relative to the die outlines, such that printing on the web will be continually registered with the die outlines.

### BACKGROUND OF THE INVENTION

The present invention relates generally to the fabrication of pouches, and more specifically to a pouch machine having a rotary die cutter which may be operated at higher speeds than those of the prior art. The invention is described in the context of pouch fabrication, but the principles disclosed can be applied in other applications, as will be evident to those skilled in the art.

Flexible plastic and/or foil pouches (or bags) are generally fabricated from webs supplied in the form of large rolls of material. A typical pouch may be fabricated from two or more plies of 3-6 mil plastic or foil. The pouch is formed by seaming the plies around the perimeter of the pouch, leaving an open edge for loading (usually along one side of the web). The seams are made by applying heat and pressure to the areas to be seamed. If the pouches are rectangular in shape, they may be severed from the web using a guillotine type of knife, however, if the pouch has a curved shape, a guillotine knife is not satisfactory. In such cases, a rotary die cutter may be used. The present invention relates to improved methods of utilizing rotary die cutters.

Pouch machines are normally intermittently fed devices. The machine initially feeds the web material needed to form one or more pouches, then stops for various operations on the web to be performed, including forming the perimeter seams, and then restarts to feed a new section of the web. A typical pouch machine may have a seaming station, possibly a punching station, a notching station, and finally a cutoff station. At a minimum, a seaming station and a cutoff station will be present. The web is advanced through each of the stations used to fabricate a particular pouch before it is completed, and then the pouch is severed from the web.

A rotary die cutter is comprised of two relatively large diameter cylinders whose axes are parallel, and whose surfaces are almost touching, or sometimes actually touching. The cylinders are either geared together or frictionally coupled, such that they have identical surface speeds. One of the cylinders (called a “die roller”) usually includes several outlines of the pouch (called “repeats”), each formed by a narrow knifelike member extending outward of the cylinder.

The other cylinder (called an “anvil”) has a smooth surface that, as the name implies, acts as an anvil for the knife. As the cylinders rotate, with the web between them, the web is crushed between the knife and the anvil, and the pouch is severed from the web. Ordinarily, the knife does not actually touch the anvil, but is spaced closely enough to cause the pouch material to be cut. The surfaces of the knife and anvil are preferably made very hard for longevity. A “skeleton” of waste material is left after the desired pouch is severed, and is discarded.

Commonly, there is printing on the web to identify the pouch contents and/or to attract buyers. Additionally, there are usually marks, called “eyespots”, printed on the web to aid in registering the printing at the various fabrication stations. The distance between the eyespots determines the length of the movement of the web as it is pulled through the pouch machine. Each movement (or “draw”) can be equal to one or many eyespot repeats, depending on the particular machine. A pouch machine typically employs a photosensitive sensor to detect the eyespots, and a controller that adjusts the web movements to be a multiple of the distance between them.

Unfortunately, the repeat distance of eyespots along the web may vary somewhat in the course of a production run. This variation in distance may be caused by changes in web tension, temperature variations, or by other factors. The variation creates problems in maintaining registration of the cutoff function of rotary die cutters with respect to seams and printing on the web.

According to the prior art, when a rotary die cutter was used to form the final cut out of a shaped pouch, the spacing of the repeats on the die roller was set to the average repeat width on the web. In order to correct the unavoidable buildup of spacing errors, the location of the rotary die assembly with respect to the previous fabrication station was adjusted from time to time as misregistration was detected. Adjusting the distance between stations works reasonably satisfactory at slow speeds. However, to run at higher speeds it is impractical to change the distance between stations, as is often required.

There is a need in the art for a pouch machine with a rotary die cutter which may be operated at higher speeds than that of the prior art. Hence it is an object of the present invention to provide a pouch machine with a rotary die cutter that automatically corrects for variations in the actual distances between eyespots, permitting higher speeds to be achieved without constant operator attendance.

### SUMMARY OF THE INVENTION

It should be noted at the outset that in most cases the “top” of a pouch made in accordance with the principles discussed herein will coincide with one side of the web from which the pouch was fabricated. The “width” of the pouch will then be formed along the length of the web. Accordingly, some dimensions, when spoken of in connection with the web may be referred to as a “length”, but when in connection with the resulting pouch such dimensions may be referred to as a “width”. The meanings of the words “length” and “width” as used herein, therefore, are dependent on the context.

In the pouch making method of the present invention, the distance between the stations is not changed, rather, the web position relative to the cutting dies is adjusted during each severing operation to properly position the web with respect to the die roller so as to maintain proper registration.

A rotary die cutter includes a die roller and an anvil. The actual cutting is done by a sharp knifelike projection from the die roller formed to the shape of the desired pouch outline. The knife crushes the web against the anvil, thereby severing the pouch from the web. The die roller cylinder is normally at least eight inches in diameter and may have several spaced repeats (die outlines) around its circumference. The reason for using a relatively large diameter cylinder is to minimize deflections so as to exert high pressure over the entire width. Keeping the diameter of the cylinders relatively large insures a good clean cut.

The concept of the present invention will be best understood by reference to an example. The following dimensions are intended to be illustrative, and do not represent either preferred or limiting values. Assume, for example, that a pouch having a nominal repeat distance along the web of 4.00 inches is to be made, inclusive of the “skeleton” waste between pouches of 0.20 inches (i.e., the nominal width of the finished pouch is 3.80 inches). Assume also that experience has taught that variations in tension, printing, etc. over time could result in the repeats on the web varying ±0.10 inches from nominal. The pouch repeats, then, could vary from time to time during production, from 3.90 to 4.10 inches, the finished pouches themselves varying in width from 3.70 to 3.90 inches.

With the foregoing in mind, according to the present invention, the cutting die outlines on the rotary die roller are made with repeats (conveniently thought of as the “leading edge” to “leading edge” distances between the cutting die outlines) slightly further apart than the maximum expected web repeat, say 0.05 inches longer, or 4.15 inches. The cutting die outlines are made the same amount longer, i.e., in this case 3.95 inches. Then, during the cut for each pouch, the web motion is retarded relative to the die roller by momentarily slowing the nips feeding the web to the die cutter so that the next pouch pattern will be in proper position to be severed by the next die repeat. Hence, if the web repeats happen to be 4.10 inches, the web is retarded 0.05 inches during the cut so that 4.10 inches of web actually traverse the die cutter while the motion of the die roller circumference is 4.15 inches. Similarly, if the web repeats are 3.90 inches, the retardation is 0.25 inches, resulting in a 3.90 inch repeat (3.70 of pouch plus 0.020 waste). In this way, irrespective of variations in eyespot repeat distance along the web, the pouches produced will have widths dependent on the current eyespot repeat distance along the web.

The position of the die roller repeats is monitored by an encoder coupled to the roller, while the locations of the web repeats is monitored by a photosensitive detector (a “sensor”) that detects eyespots printed on the web in registration with the web repeats.

The invention is described in greater detail in the below detailed description and in the accompanying drawings, from which a more comprehensive understanding of the invention may be had.

### BRIEF DESCRIPTION OF THE DRAWINGS

FIG. 1 is a schematic side view of a pouch machine with a rotary die cutter embodying the present invention.

FIG. 2 is a perspective view of a fully assembled rotary die cutter as used in connection with the present invention.

FIG. 3 is a perspective view of a rotary die cutter as used in connection with the present invention, with a side plate removed.

FIG. 4 is a cross sectional end view of a die roller having a plurality of cutting die outlines thereon.

FIG. 5 is an enlarged cross sectional end view of a die roller and an anvil showing a pouch being severed from the web.

FIG. 6A is a plan view of a section of the web showing the perimeter seams of several representative pouches, and associated eyespots.

FIG. 6B is a plan view of a representative completed pouch.

FIG. 7 is a flowchart depicting the steps involved in one embodiment of the process of the present invention.

### DETAILED DESCRIPTION OF THE PREFERRED EMBODIMENTS

While the following description is couched in terms of a “pouch” it will be appreciated that the term is meant to include “bags” “containers”, “packages” and/or other similar items.

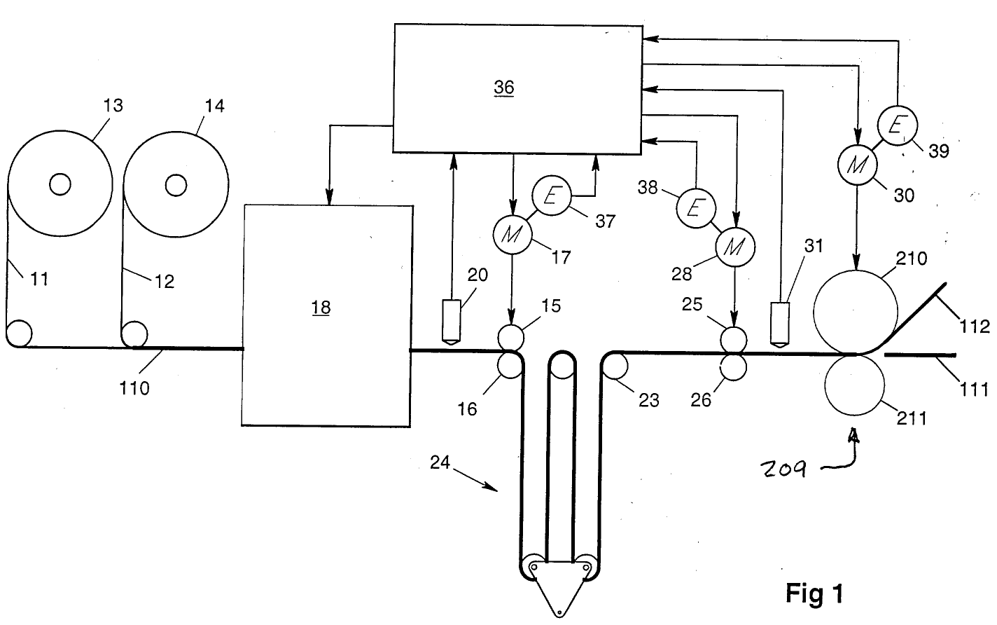

FIG. 1 is a schematic side view of a pouch machine having a rotary die cutter and embodying the present invention. The construction of pouch machines is generally known, so that constructional details are unnecessary to convey a knowledge of the invention to those skilled in the art. For illustrative purposes, a pouch machine is shown which produces an arbitrarily shaped pouch. A shaped pouch includes at least two plies seamed together around three of its four sides, the fourth side seam normally being made after the pouch is completed and the desired contents inserted. It was noted in the Background section of this specification that pouch machines may include four or more sections each of which performs a particular operation on the passing web. For explanatory simplicity, the machine shown in FIG. 1, includes a generalized station 18 that represents all of the operations not specifically impacted by the present invention, and a cutoff station that includes a rotary die cutter.

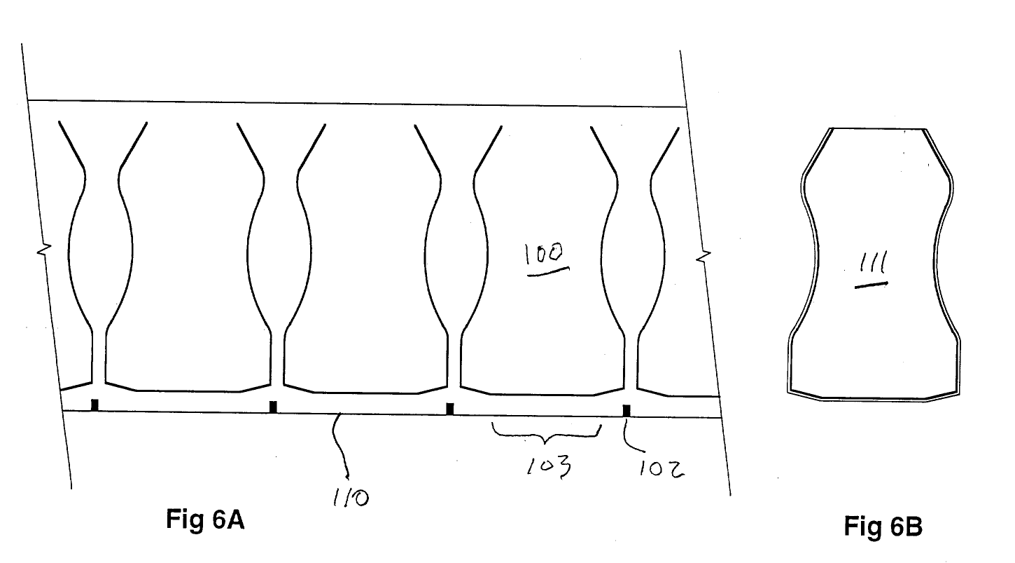

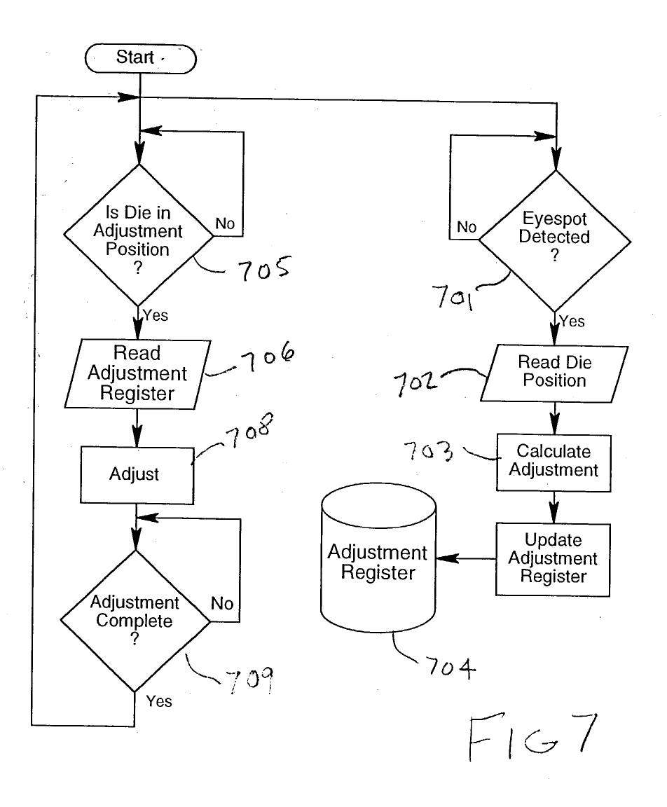

As seen in FIG. 1 two webs of sheet stock 11 and 12 are fed into the pouch machine from rolls 13 and 14 to form a web 110. The webs 11 and 12 are drawn (under tension) into the machine by rollers 15/16. One or both rollers 15/16 are driven by a motor 17. The rotation of the motor 17 is monitored by an encoder 37, and the rotational information is sent to the controller 36. The motion is intermittent in that the webs 11/12 are drawn rapidly into the machine for a period of time to draw in new material, and then the motion is stopped for some other period of time to allow the pouch perimeter seams to be made, as well as other operations such as punching or notching to be performed. The numeral 18 represents the apparatus for performing all of these operations, which are old in the art, and are not discussed in detail. The flow of the web through apparatus 18 is monitored by sensor 20, which detects eyespots which have been preprinted along the web. FIG. 6A shows a short section of the web 110 that includes the perimeter seams for several pouches, and the associated eyespots. In this figure, eyespot 102 is associated with potential pouch 100. As is known in the art (see, e.g., U.S. Pat. No. 5,800,325), each cycle of the apparatus 18 may produce one or many pouches, but whatever the number, the web, after all preliminary operations have been performed by apparatus 18 is fed into accumulator 24 by nip rolls 15/16.

The nip rollers 25/26 withdraw material from the accumulator station of the pouch machine and feed it to the rotary die cutter 209. One or both of the nip rollers 25/26 are driven by a variable speed motor 28. The rotation of the variable speed motor 28 is monitored by an encoder 38 and the rotational information is sent to the controller 36.

Sensor 31, which is preferably located between nip rollers 25/26 and rotary die cutter 209, detects each eyespot on the web 110 as it passes. The controller 36 receives information from sensor 31, the encoder 38, and the encoder 39.

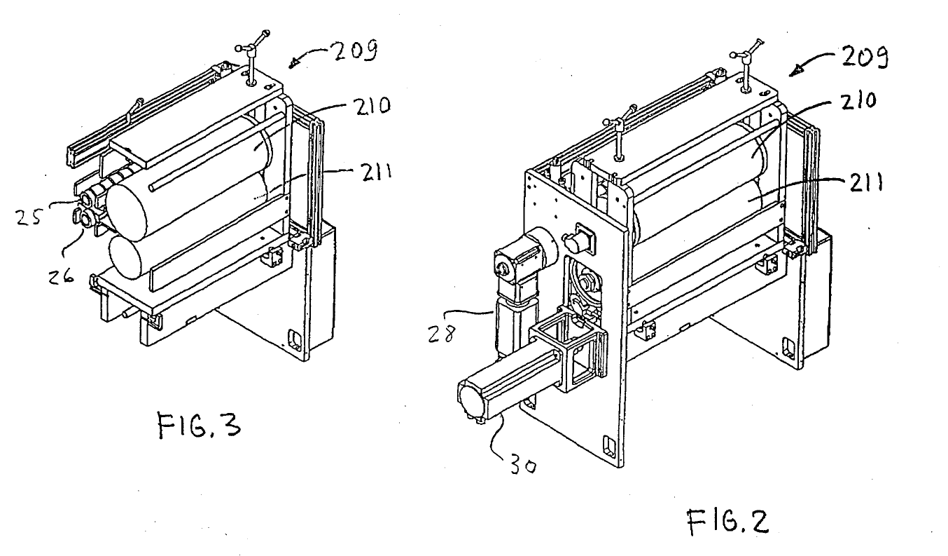

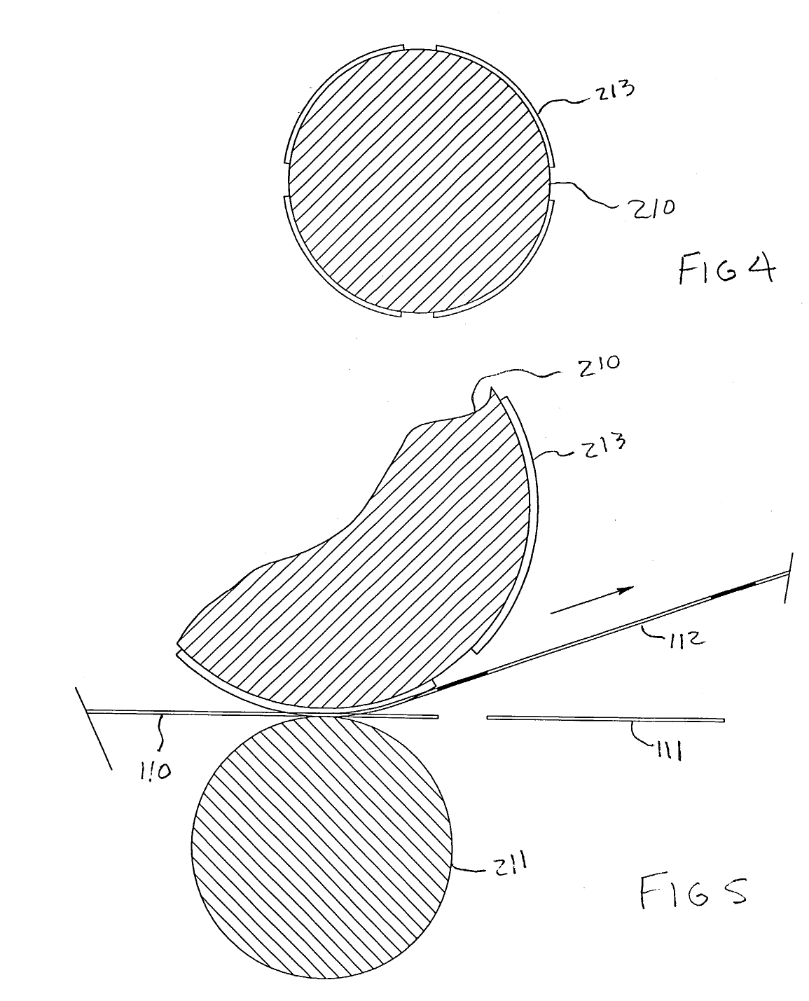

As best seen in FIGS. 2 and 3, the rotary die cutter 209 includes an anvil 211 and a die roller 210. The anvil 211 and the die roller 210 are preferably engaged with each other with gearing or a frictional drive such that both have identical surface speeds. The die roller includes one or more cutting die outlines 213 around its periphery (see FIGS. 4 and 5). As will be discussed further below, in some embodiments of the invention, the lengths of the cutting die outlines 213 around the die roller are made slightly longer than the nominal pouch width.

A servo motor 30 drives the anvil 211 and the die roller 210. The rotation of motor 30, and hence the location of the die outlines 213 on the die roller 211, are monitored by encoder 39. As the web 110 passes through the rotary die cutter, the cutting dies 213 sever the pouches (e.g., pouch 111 as shown in FIG. 1), leaving the skeleton 112, which is discarded.

The underlying concept of the method of the present invention is to 1) make the distance between successive leading edges of the die outlines on the die roller slightly longer than the maximum anticipated distance between successive eyespots on the web, and 2) during the cutting of a pouch from the web, to momentarily retard the web feed relative to the die roller surface so that the amount of web fed between successive die leading edges is equal to the eyespot to eyespot distance of the specific pouch being severed.

The process involves two separate functions, as illustrated on the flow chart of FIG. 7: 1) making a determination of the amount by which the web should be retarded during a particular cut (the adjustment), as is illustrated on the right half of FIG. 7, and 2) effecting the adjustment, as is illustrated on the left half of the Figure.

In an illustrative embodiment of the invention, the sequence of events is as recited below. The numerical example given has been chosen for the purpose of simplicity of explanation. It will be appreciated that the various sizes, the locations of the eyespots, the location of the photo sensor, and other parameters could be different in particular cases and still be within the spirit of the invention. The explanation is written describing the operation of a single die repeat on the die roller, however, those skilled in the art will readily understand how to extend the principle described to additional die outlines (if any) around the periphery.

For this example, assume the same size pouches are to be made as mentioned in the Summary section above, i.e:

a) A nominal pouch repeat of 4.00 inches (on the web), which might vary ±0.10 inches over time, including a waste of 0.20 inches (the skeleton waste between pouches), and

b) The cutting die repeats on roller 210 are spaced 4.15 inches (leading edge to leading edge), that is, slightly more than the largest anticipated leading edge to leading edge distance of the pouches along the web (0.05 inches more). The cutting die outlines are also longer than nominal, by the same amount as the die repeats (0.15 inches more than nominal in this example).

Further assume that:

c) The eyespots on the web are aligned with the leading edges of the pouch patterns, and that sensor 31 is located one nominal repeat distance (4.00 inches) upstream of bottom dead center of roller 210 (BDC), and

d) Encoder 39 provides −1000 counts per inch of travel at the surface of the cutting dies on roller 210. The negative rate (−1000) reported by the encoder indicates that the count goes down as the rollers rotate. The “zero” setting of the encoder for purposes of this example is that it reports a count of 150 when the leading edge of the first die repeat passes BDC. The count is higher (by 1000 counts/inch) before BDC, and lower by the same amount after BDC. As noted above, the specific numbers used herein are for the purpose of explanatory ease, and not because of any inherent advantage. Simple arithmetic computation can treat any encoder count rate and/or zero settings to achieve the required adjustment.

With the foregoing assumptions, it is easily seen that if the eyespots on the web are exactly the nominal distance apart (4.00 inches), encoder 39 will report a count of 150 when an eyespot is detected. This is because the eyespots are aligned with the pouch leading edges, sensor 31 is located exactly one nominal repeat distance from BDC of die roller 210, and the encoder reports a count of 150 when the leading edge of the die repeat is at BDC.

If, on the other hand, the eyespot to eyespot distance were 3.90 inches (the anticipated low limit of pouch repeats), it can be seen that when an eyespot is detected, the leading edge of the die will be 0.10 inches before BDC, and the encoder will therefore report a count of 250. And similarly, if the eyespot to eyespot distance is 4.10 inches (the anticipated high limit of pouch repeats), the leading edge of the die will be 0.10 inches after BDC, and the encoder will report a count of 50.

Because the encoder parameters for the above example were chosen for ease of calculation, it can easily be seen that if the web is retarded during the cut by the number that encoder 39 reports times 0.001 inch, a pouch repeat distance will result that is exactly equal to the distance between the eyespots for that particular pouch.

The flowchart of FIG. 7 illustrates the foregoing in a more general fashion. Initially, the control system 36 is waiting for sensor 31 to detect an eyespot (decision block 701). When an eyespot is detected, the roller die position is read by encoder 39 (block 702) and the amount of nip retardation needed to align the next leading edge of the cut with respect to its related eyespot is calculated as shown by block 703. For the example given, the calculation is 0.001 times the reading of encoder 39. Adjustment register 704 is then updated, storing the amount of retardation needed to accomplish the foregoing. Preferably the steps 701 through 704 are accomplished near the beginning of the cut so as to provide an opportunity for the adjustment to be made before the pouch is completely severed.

After the amount of retardation is determined, and stored, the system waits until an appropriate time to execute the retardation. The adjustment (retardation of the web with respect to the die roller) can occur any time when the two sides of the pouch are substantially parallel to the edges of the web. During setup of the machine, a section of the pouch having the appropriate characteristic is identified, and the encoder 39 reading corresponding to some point in this region set into memory. For example, the region marked 103 in FIG. 6A is a region where the sides of the cut are parallel to the length of the web, and is therefore a region suitable for making the adjustment.

Referring back to FIG. 7, when the die roller gets to the position where the encoder 39 reading equals the number set into memory (identifying the parallel sides region), decision block 705 detects that the web is in position for the adjustment to be performed, and the adjustment register is read as indicated by block 706. Motor 28, pursuant to signals from block 708, thereupon momentarily reduces the speed of nips 25/26 until the amount of retardation of the web with respect to die roller 210 equals the amount set in the adjustment register 704, and then resumes speed.

Decision block 709 detects when the adjustment is complete and then reactivates decision blocks 701 and 705 for the next pouch to be severed.

It will be noticed that in the example described above, sensor 31 was situated 4.00 inches upstream of the die roller BDC. The information stored in the adjustment register in this case relates specifically to the single pouch being severed, which means that the system can accommodate pouch widths that randomly vary between the high and low limits. If, which is the more usual case, the variation in pouch widths occurs slowly over time, sensor 31 can be placed further upstream, say several pouch widths, and still provide the information needed to allow a correct adjustment.

In some cases, the pouches to be made may be shaped so as not to include a region 103 where the side cuts are parallel to the web length. In such a case, the adjustment can be made during the interval between the trailing edge of one die repeat and the leading edge of the next repeat. One difference that exists with this mode of operation is that, while the cutting die repeats on the die roller are made longer than the maximum anticipated eyespot repeats on the web, as in the first embodiment, the length of the cutting die itself is not made longer, but is made equal to the nominal length. The result is that, in this embodiment, the finished pouches are all of the same width, as opposed to widths that vary depending on the variation in eyespot spacing. The variations in eyespot spacing is taken up in variation in the length of the waste.

What has been described is a pouch machine and method for fabricating pouches at speeds which have heretofore been considered impractical. Persons skilled in the art will no doubt be able to make various modifications and adaptations of the invention, but yet be within the inventive teaching disclosed herein, either explicitly or implicitly. The limits of the invention sought to be protected are defined by the following claims.

I claim:

1. A method of severing articles from a web which comprises the steps of:
providing a web comprised of one or more plies, at least one of said plies having substantially equally spaced eyespots printed thereon, each of said eyespots having a predetermined relationship with one of said articles to be severed;
providing a continuously rotating rotary die cutter having a die roller including one or more cutting die outlines of an article to be severed around its periphery, the distances between successive leading edges of said die outlines being greater than the distances between said eyespots along said web, said cutting die outlines being adapted to cut through the plies of said web;
feeding said web into said rotary die cutter;
detecting an eyespot on said web;
determining the rotational position of one of said cutting die outlines at the time said eyespot is detected;
calculating how the speed of feeding said web should be momentarily reduced to register the leading edge of the next successive cutting die outline with the next successive article on said web; and
momentarily reducing the feed of said web into said rotary die cutter responsive to said calculation.

2. The method of severing pouches of claim 1, which further comprises the step of:
storing the results of said calculation in a register; and
momentarily reducing the feed of said web into said rotary die cutter responsive to the contents of said register.

3. The method of severing pouches of claim 1, which further comprises the step of:
detecting a region of the web where the edges of the article being severed are substantially parallel to the sides of the web, and performing the step of reducing the feed of said web while said cutting die outline is cutting within said region.

4. The method of severing pouches of claim 1, which further comprises:
performing the step of reducing the feed of said web between the time the trailing edge of a cutting die outline has finished cutting through said plies, and the time that the leading edge of the next cutting die outline begins to cut through said plies.

5. A method of fabricating pouches which comprises the steps of:
providing a web of pouch material comprised of one or more plies of pouch material;
providing a series of substantially equally spaced eyespots on said web;
providing a continuously rotating rotary die cutter having a die roller including one or more cutting die outlines of a pouch around its periphery, the repeat distance of said cutting die outlines being greater than the repeat distance of said eyespots;
feeding said web into said rotary die cutter to sever a pouch;
determining the position of one of said die outlines with respect to said web relative to an eyespot;
calculating how the speed of feeding said web should be momentarily reduced to register the next successive pouch to be severed with the next successive cutting die outline; and
momentarily reducing the speed of feeding of said web into said rotary die cutter responsive to said calculation.

6. The method of severing pouches of claim 5, which further comprises the step of:
storing the results of said calculation in a register; and
momentarily reducing the feed of said web into said rotary die cutter responsive to the contents of said register.

7. The method of severing pouches of claim 5, which further comprises the step of:
detecting a region of the web where the edges of the pouch being severed are substantially parallel to the sides of the web, and performing the step of reducing the feed of said web while said cutting die outline is cutting within said region.

8. The method of severing pouches of claim 5, which further comprises:
performing the step of reducing the feed of said web between the time the trailing edge of a cutting die outline has finished cutting through said plies, and the time that the leading edge of the next cutting die outline begins to cut through said plies.

9. A web severing station for a flexible package fabrication machine, said web having a plurality of substantially equally spaced eyespots along the length thereof, said station including a continuously rotating rotary die cutter comprising:
a pair of nip rollers driven by a variable speed motor and monitored by a nip roll encoder, said nip rollers feeding said web to said rotary die cutter;
said rotary die cutter including a die roller and an anvil, said die roller including one or more cutting die outlines around its periphery, said cutting die outlines having a greater repeat distance than said eyespots;
a die roll encoder monitoring the position of said die outlines;
an eyespot sensor positioned to detect said eyespots; and
a controller receiving information from said nip roll encoder, said die roll encoder, and said photosensitive sensor, said controller momentarily decreasing the speed of said nip rollers to retard the advance of said web relative to said die roller to sever said web in register with said eyespots.

10. The web severing station of claim 9, further comprising:
means within said controller for calculating the amount by which said web should be retarded to achieve said registration between said severed package and said eyespots; and
a register within said controller for storing the results of said calculation.

11. The web severing station of claim 9, further comprising:
means within said controller for storing information identifying the region of said package wherein the edges of said package being cut are substantially parallel to the sides of said web; and
means for causing the motion of said web to be retarded only while said cutting die outline is cutting said plies in said region.

12. The method of severing pouches of claim 9, which further comprises:
performing the step of reducing the feed of said web between the time the trailing edge of a cutting die outline has finished cutting through said web, and the time that the leading edge of the next cutting die outline begins to cut through said web.
